(19) United States
(12) Patent Application Publication
(10) Pub. No.: US 2013/0020810 A1
(43) Pub. Date: Jan. 24, 2013

(54) Device to replace nuclear and fossil-fuel steam supply power plants with zero CO2 and safe efficient superheated steam

(71) Applicant: Arvind A. Daya, Fayetteville, GA (US)

(72) Inventor: Arvind A. Daya, Fayetteville, GA (US)

(21) Appl. No.: 13/317,620

(22) Filed: Oct. 24, 2011

Related U.S. Application Data
(63) Continuation-in-part of application No. 13/136,012, filed on Jul. 20, 2011.

(51) Int. Cl. H02K 7/10; F22G 3/00; H02K 7/18

(52) U.S. Cl. 290/1 C; 290/52; 122/460

(57) ABSTRACT

The invention provides processes and apparatuses for safely, rapidly, cost-effectively producing superheated steam. These processes and apparatuses involves producing clean low-cost electricity by the long rigid power arms generator thereby operating electric-arc furnaces side by side, melting steel repeatedly and tungsten steam pipes bedded in molten steel to produce superheated steam, this method of producing steam will replace nuclear, coal and other fossil fuel method of producing steam on the steam producing side of the equation without dismantling the entire nuclear or coal fired power plants, by merely discarding the nuclear side or the coal side of the either plant altogether. The use the ocean water to produce superheated steam for turbines and the distillation will produce clean drinking water, excess power from the generator through an electrolysis process will produce oxygen for the electric-arc furnace to increase temperature for steam and hydrogen gas stored as energy.

This invention relates to power plants, and in particular steam power plants. Replacing the present nuclear method and fossil-fueled method of producing steam to turn the turbines for huge power plants to generate electricity. This application is a Continuation-In-Part of my patent application U.S. Ser. No. 13/136,012 filed Jul. 20, 2011 and the contents therein contained are incorporated by reference herein.

### BACKGROUND OF THE INVENTION

### Field of Invention

The statements in this section merely provide a global need and background information related to the present disclosure and may or may not constitute prior art. A current method for operating a power plant includes nuclear, coal or other fossil-fuels steam power generator plants, both methods are of major concern, one due to radiation safety on the nuclear side and two CO₂ issues on the fossil-fuel side. The present invention tackles both of these major issues around the globe head on. A nuclear radiation accident in power plants is defined by the International Atomic Energy Agency as an event that has led to significant consequences to people, the environment or the facility. Examples include lethal effects to individuals, large radioactivity release to the environment, or reactor core meltdown. The prime example of a “major nuclear accident” is one in which a reactor core is damaged and large amounts of radiation was released, such as in the Chernobyl Disaster in 1986 around the globe.

More gravely serious truths about the severity of the Fukushima nuclear power plant disaster following the earthquake and tsunami of Mar. 11, 2011 in Japan have emerged. “Japan, the world's third-largest user of electricity behind China and the United States, had counted on an expansion of nuclear power to contain energy costs and greenhouse gas emissions.

Instead, its nuclear program is in retreat, as the public and the government officials urge a sharp reduction in the nation's reliance on nuclear power and perhaps an end to it altogether.” Following Germany's coalition government has announced a reversal of policy that will see all the country's nuclear power plants phased out by 2022. The decision makes Germany the biggest industrial power to announce plans to give up nuclear energy including Switzerland, Italy there will be more to come to phase out nuclear and fossil-fuel around the world.

Burning coal and other fossil-fuel is a leading cause of smog, acid rain, global warming and air toxics. In an average year, a typical coal plant generates 3,700,000 tons of carbon dioxide (CO₂) The American Lung Association (ALA) recently released a new report on the dramatic health hazards surrounding coal-fired power plants. The report, “Toxic Air: The Case For Cleaning Up Coal-Fired Power Plants,” reveals the dangers of air pollution emitted by coal plants. One of the starkest findings in the report claims, “Particle pollution from power plants is estimated to kill approximately 13,000 people a year.” Globally, power generation emits nearly 10 billion tons of CO₂ per year. The U.S., with over 8,000 power plants out of the more than 50,000 worldwide, accounts for about 25 percent of that total or 2.8 billion tons CO₂. Capital costs for Integrated Gasification Combined Cycle (IGCC) plants are estimated to be 20-47% higher than traditional coal plants. In 2004, Indeck Energy Services testified before the Illinois State EPA that IGCC's “capital costs are 30% higher.” General construction costs (concrete, steel and labor) have raised 100-300% in recent years, driving up the costs of all power plants. The Department of Energy (DOE) reports that IGCC is seen as too risky for private investors, and requires large subsidies from the federal, state and local governments. In 2006, the EPA estimated that capturing 90% of CO₂ emissions from IGCC plants would increase capital costs 47%; and the total cost of electricity 38%. “Capture” does not include transportation of gas or storage. Compression costs have been estimated at $17/ton CO₂, so a 600 MW plant emitting 4-5 million tons/year of CO₂ would cost approximately $68-85,000,000/year just for compression.

In the present invention of producing clean safe superheated steam to run existing power plants is been addressed, both issues, the nuclear radiation safety and the fossil-fuel pollution CO₂, furthermore these plants can use the ocean water to produce steam and upon condensation and distillation of steam to clean drinking water, with excess electricity, hydrogen can be produced.

### SUMMARY OF THE INVENTION

In the present invention the initial clean electricity of 8 MW to 10 MW on the long rigid power arm generator method to produce steam to decommission the nuclear side of the power plant and coal fired side of the power plant by a conventional electric-arc steelmaking furnaces, direct arc type where the current passes through electrodes, across the arc created between the foot of the electrodes and the molten metal and thick tungsten steam pipes below the molten metal and across another arc to adjacent electrodes. The electric-arc provides a very intense source of high temp heat (as high as 6300 degrees F. for carbon arc.) that would bring the surface of the tungsten steam pipes to cherry red to produce superheat steam in these pipes as the preheated water/steam flow through the furnace and turn the steam turbines to generate electricity.

To generate the initial electricity for this present invention is to refer to the patent U.S. Ser. No. 13/136,012, where there are several long rigid power arms on a shaft and the shaft is attached to the gearbox whereby the generator. The long rigid power arms on the generator are ratcheted and reciprocated to turn the gearbox at low rpm whereby generator to generate the required energy to operate the electric-arc smelter to produce steam. As the long rigid power arms ratcheted reciprocated with an aid of a one-way clutch, ratchet mechanism on the gearbox shaft. There are several key improvement on this invention is included in the present invention to accommodate this present invention as shown in drawings.

The one-way clutch (ratchet action) of large heavy duty capacity that requires hi torque on low rpm on large diameters shaft by a new and improved method is included in this invention. One-way clutch systems permitting, for low rpm, a driven member to be positively driven by a driving member in one direction only, being capable of free-wheeling or over-run relative to the driven member. When not in driven engagement with the driving member. Conventional frictional one-way clutches have therefore inherent limitation in torque transmittal capacities, which depend on the frictional effect of the surfaces in contact, diameter, in life due to wear, and in the permissible relative speeds of rotation during free-wheeling and over-run. The present invention remedies the disadvantages and shortcomings of the prior art by providing several different type of one way clutch apparatus that could be used, any one type or combination be fixed on a common shaft to turn the gearbox whereby the generator to perform the so called one-way clutch action where a driven member to be positively driven by a driving member in one direction only, being capable of free-wheeling or over-run relative to the driven member and maintaining the hi torque of 1,000,000 ft-lb of torque and higher required to positively drive the driven member without fail for low rpm as 2 to 12 rpm situations. There are several methods used in this present invention to achieve low rpm and hi torque of a driven member to be positively driven by a driving member in one direction only, being capable of free-wheeling or over-run relative to the driven member when not in driven engagement with the driving member. The low rpm and hi torque one-way clutch mechanism in first method, ranging from 40,000 ft-lb to 950,000 ft-lb plus of torque and the second method from 950,000 ft-lb of torque to 3,500,000 ft-lb and greater as required, the FIG. 6a-b shows lower torque capacity type device and FIG. 5a-b for larger torque capacity device.

The first one-way clutch method, low rpm and hi-torque one-way clutch mechanism ranging from 40,000 ft-lb to 950,000 ft-lb is achieved by using in the present invention, for example a 15 inch broad auto tire and high strength steel rim and/or two of the 17 inch brake disc attached to the gearbox shaft, the long rigid power arm at one end of this arm is attached with a thick steel rigid metal band and 2 brake disc calipers for each disc rotor is fixed the arm, as shown in FIG. 6a-b, ratchet action of the said shaft is caused by the reciprocating of the long rigid power arm that is attached to the gearbox shaft where the generator is turned. The metal band around the outer tire with a space between tire and the circular thick steel rigid band with “Z” type spring loaded pawl to a metal strip attached on the inner circumference of the thick rigid steel metal band by binding at any location on the surface of tire, thus turning the tire and the rigid steel band in one direction, upon ratchet reciprocation of the long rigid arm. The ratchet reciprocation of the long rigid power arm and binding of the “Z” type spring loaded pawl with metal strip and the four individual disc brake calipers on the rotors that are applied which are on the long rigid arms are locked on the steel rotors mechanically or micro-processor controlled, as in FIG. 6 and released upon opposite rotation, causing the continues rotation of the gearbox shaft whereby generator to produce electricity and maintain the specified rpm to the designed 60 Hz or 50 Hz and to overcome enormous torque required by the generator. The second one-way clutch method used in this invention for the long rigid arms is to turn the large gearbox whereby the generator to produce 8 MW to 10 MW of electric power on the long rigid power arm generator to produce superheated steam from the two “electric-arc steel smelting furnace” side by side, these smelters produce superheated steam instead of smelting steel as designed for the nuclear power plant or coal fired power plant. The one-way clutch action in this invention is attached in similar manner as the first one-way clutch on a auto tire as mentioned earlier except in this method a large tractor trailer rear tires and two rims as a pair of two rims combined with two truck brake drums on the said tire rims as in FIG. 5a-b, on both sides of the long rigid arms at midpoint of the arms, the truck tire and the rims are fixed to the shaft to the turn gearbox whereby the generator. The ratchet reciprocation of the long rigid power arms and binding of the “Z” spring loaded pawl steel strips on the large rigid thick metal binding band on the tires, and the brake are applied either mechanically and/or microchip-processor controlled and applied, thus turning the gearbox whereby generator.

The electric-arc steelmaking furnaces are implemented in the present invention to produce superheated steam to turn the turbine generators. In the electric-arc furnaces, the electric current passes through electrodes, across the arc created between the foot of the electrodes and the metal bath, then through metal bath and up across another arc to the adjacent electrodes. Just below the metal bath is rows of thick tungsten tubes of water/stream been pump through the tubes creating superheated steam. The electric-arc provides a very intense source of high temperature heat (6300 degrees F. form carbon arc), heat being radiated from along the length of the arc and generated at the interfaces of arc/metal and arc/electrode. These locations of high temperature referred to herein as the “arc flare zone”. The arc constitute a variable resistance in the circuit which can be altered by raising or lowering the electrodes to change the arc length and temperature, furthermore oxygen and blend of air mix is injected in the smelter to increase temperature that's regulating the superheated steam quality to supply the turbine generator to generate electricity, thus easily obtaining pressures of 2400 psig to 3500 psig at temperatures around 1000 degrees F. production of steam can be maintained, for increase demand of steam can be met by additional smelter units.

The present invention can be implemented on a new power generating plants similar to the existing ones without the nuclear safety issues, and fossil fuel CO₂ issues. There are many other positive outcome in implementing this invention, such as; producing clean drinking water from the ocean waters distillation process, irrigation of desert land, use of minerals from distillation of ocean salt water, produce hydrogen from excess electrical power generated during off peak hours of the day at every gas (petrol) station to power automobiles with hydrogen fuel without an extensive modification to existing motor vehicle, hydrogen as jet fuel without CO₂ pollution for aircraft.

### BRIEF DESCRIPTION OF DRAWINGS

FIG. 1 depicts side view of a single long rigid power arm with the lead weights load retracted on sliding platform as the sprocket roller chain frame mechanism takes the arm upwards.

FIG. 2 depicts side view of a single long rigid power arm with the lead weights load extended on the sliding platform as the sprocket roller chain frame mechanism takes the arm downward.

FIG. 3 depicts front view and the side view of the sprocket gears and roller chain mechanism to control six in this case long rigid power arms movement upwards and downwards as conveyor.

FIG. 4 depicts propulsion coils moving equal weights creating a swinging gravity force by long rigid power arm.

FIG. 5 depicts front view in 4b and side view in 4a as a one way clutch apparatus on a set of truck tires and brake drums combine on a thick metal band to turn a larger generator.

FIG. 6 depicts a front view and side view of disc rotors and car tire rapped with thick metal band as one way clutch action to turn small generator.

FIG. 7 depicts a horizontal type one way clutch device to turn the gear in one direction by pulling the chain with two sets of jaws and free it by reciprocating the arm operated by pneumatic cylinder.

FIG. 8 depicts air or hydraulic operated multi-disc clutch as a one way clutch action (slip-grip action) on the long rigid power arm.

FIG. 9 depicts an electric arc iron smelter exclusively to produce superheated steam.

### DETAILED DESCRIPTION OF THE PREFERRED EMBODIMENT

The invention will be further described in detail with reference to the drawings;

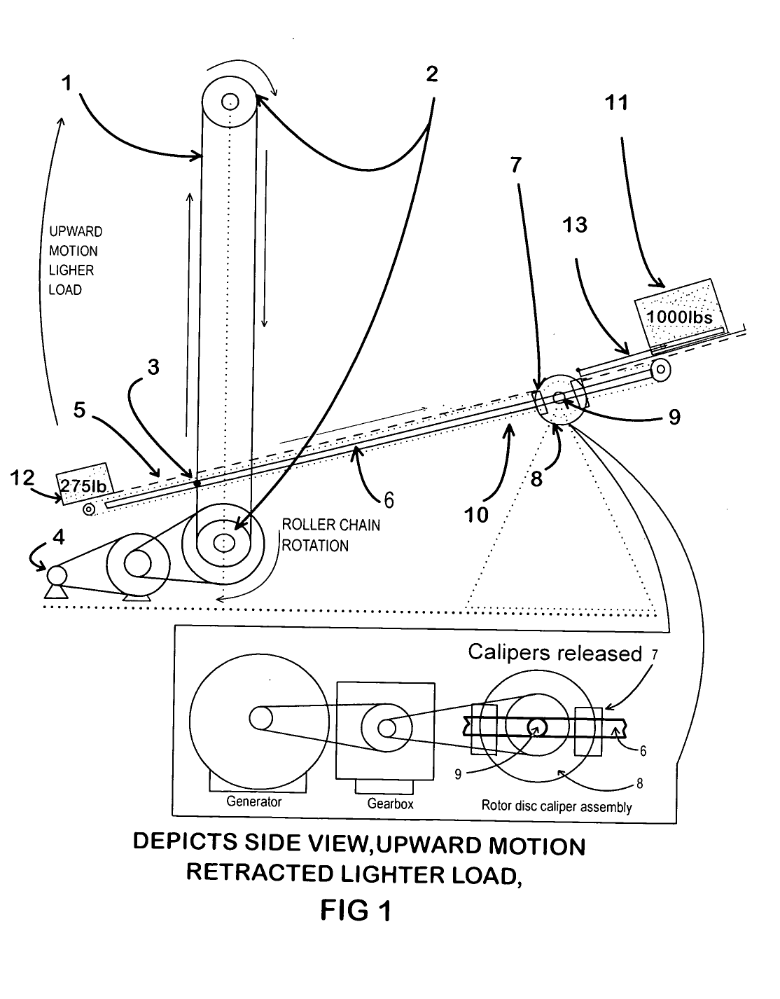

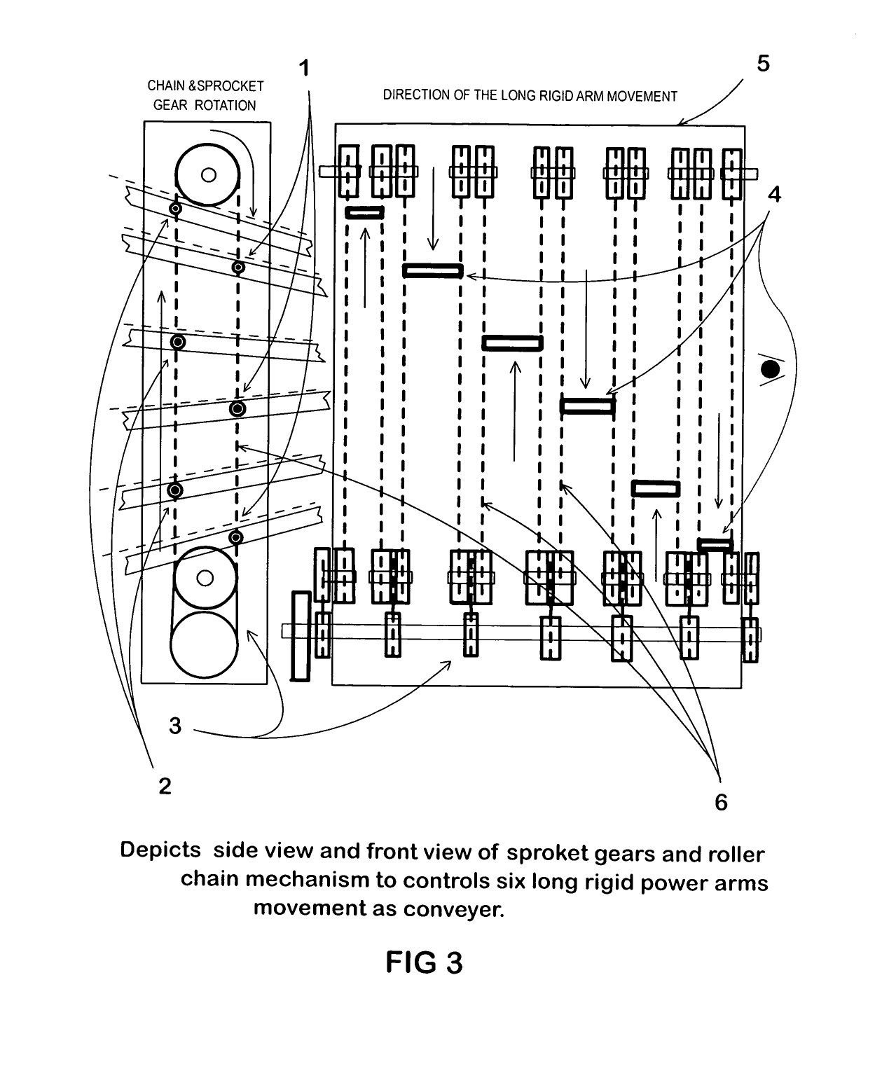

Referring to the drawings, the gravity force on the present invention for generating electricity is illustrated in the FIG. 1. the upward motion of the long rigid power arm 6 is achieved by the force of the rest of the arms that going down as displayed in FIG. 3, sprocket roller chain frame mechanism, just prior to the upward motion of the rigid power arm 6, disc rotor 8 attached to the gearbox shaft 9 is released by the calipers 7 operated by micro-processor, the lighter lead weight load in front 12 retracted and the heavier lead weight at the back 11 is retracted pass the pivot point 9 at the gearbox shaft on a separate sliding platform 5, furthermore the rear 10001b heavier lead load 11 as in this case is push back by short air cylinder or a ball screw 13 an additional distance all controlled by micro-processor causing the larger lead weight 11 load to help lift the front lighter lead 12 load by pivoting at 9 causing upward motion of the long rigid power arm, similarly the rest of the long rigid power arms going upward benefits in same manner repeatedly, this retraction action of the sliding platform 5 on the long power rigid arm 6 is caused by a hydraulic/air cylinder, linier ball screw drive motor or roller chain conveyor system 10 (shuttle traction) controlled by micro-processor, the rotation of the roller chains 1 on sprocket gears 2 on the sprocket frame conveyor FIG. 3 causing a uniform movement of all the long rigid power arms, furthermore a electric motor 4 maintains the timing and the speed at which the roller chain loop 1 around the sprocket gears 2 with the long rigid power arm attached to the roller chain at 3 been lifted as the roller chain circulates around the sprocket gears 2.

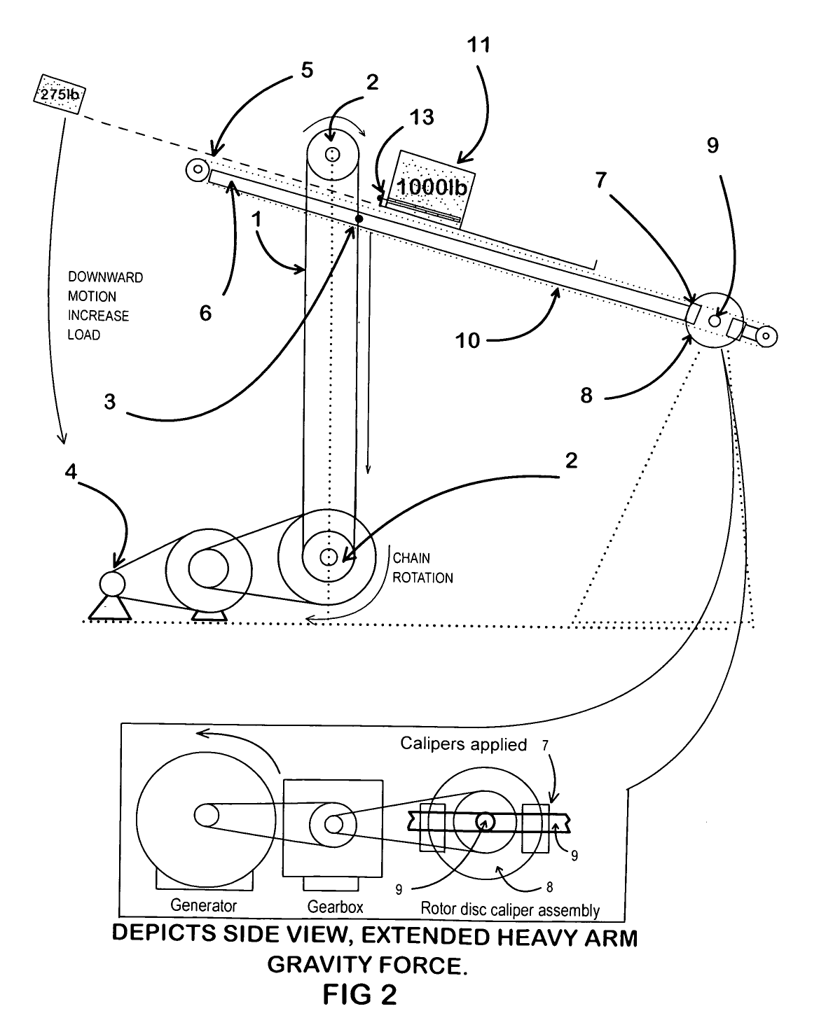

Referring to FIG. 2 the descending motion of the long rigid power arm produces the energy needed to turn the gearbox whereby the generator in a form of gravity where the arm is fixed to the roller chain at 3 and the sliding platform 5 extended along with a short rod 13 retracted to pull the 1000 lbs as in this case closer to the sprocket gear roller chain mechanism 3 on bearings all operated by a linear ball screw driver or roller chain conveyor type apparatus (shuttle traction) 10, and the caliper brakes 7 are applied to turn gearbox shaft 9 whereby the generator, the descending action of the long rigid power arm with added lead weights by the sliding platform extended would exert tremendous gravity pressure to turn the gearbox shaft whereby the generator.

Referring to FIG. 3, this device has unique qualities, it provides accurate timing of the long rigid power arms motion control, where in this case three arms are on a upward motion 2 and three are in descending motion 1, upon the descending motion gravity energy is transmitted trough the long rigid power arms 4 attached on the linier motion bearing pillar blocks 1 to the roller chains 6, as the roller chains 6 with the long rigid power arm descends thus turns gearbox shaft whereby the generator, all the sprocket gears 3 in this frame 5 are the same size to maintain constant speed and all gears to maintain the desired 50/60 hertz frequency from the generator, the other advantage this device provides is dividing the torque required by the generator to produce electricity equally to all descending long rigid power arms 1 thus they work uniformly continuously, since the torque is shared equally thus reducing the resistance that is applied to the each of the one way clutch apparatus on the long rigid power arm, furthermore the upward moving long rigid power arms are assisted to go up by the gravity applied by the downward moving long rigid power arms.

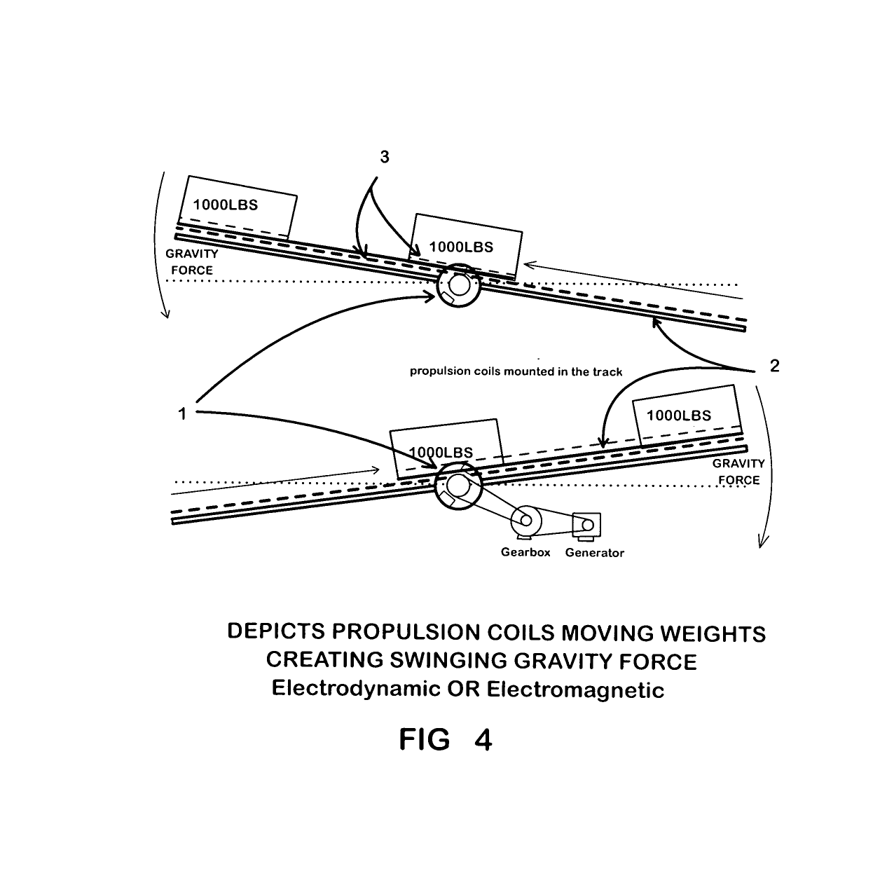

Referring to FIG. 4 as the long rigid power arm 2 swings back and forth the one way clutch mechanism 1 at midpoint is operated by a microprocessor along with the magnetic repulsive force in the track is created by an induced magnetic field 3 in wires or other conducting strips in the track, where the long rigid power arm 2 swings at midpoint as the magnets 3 moves the combine equal weights from side to side to create gravitation force on both side of the swing and the one way clutch 1 along with the propulsion coils 3 are controlled and regulated by micro-processor, thus the required rpm by the generator is maintained. Multiple long rigid power swinging arms can combine to turn a common shaft to overcome the torque required by the gearbox whereby the generator.

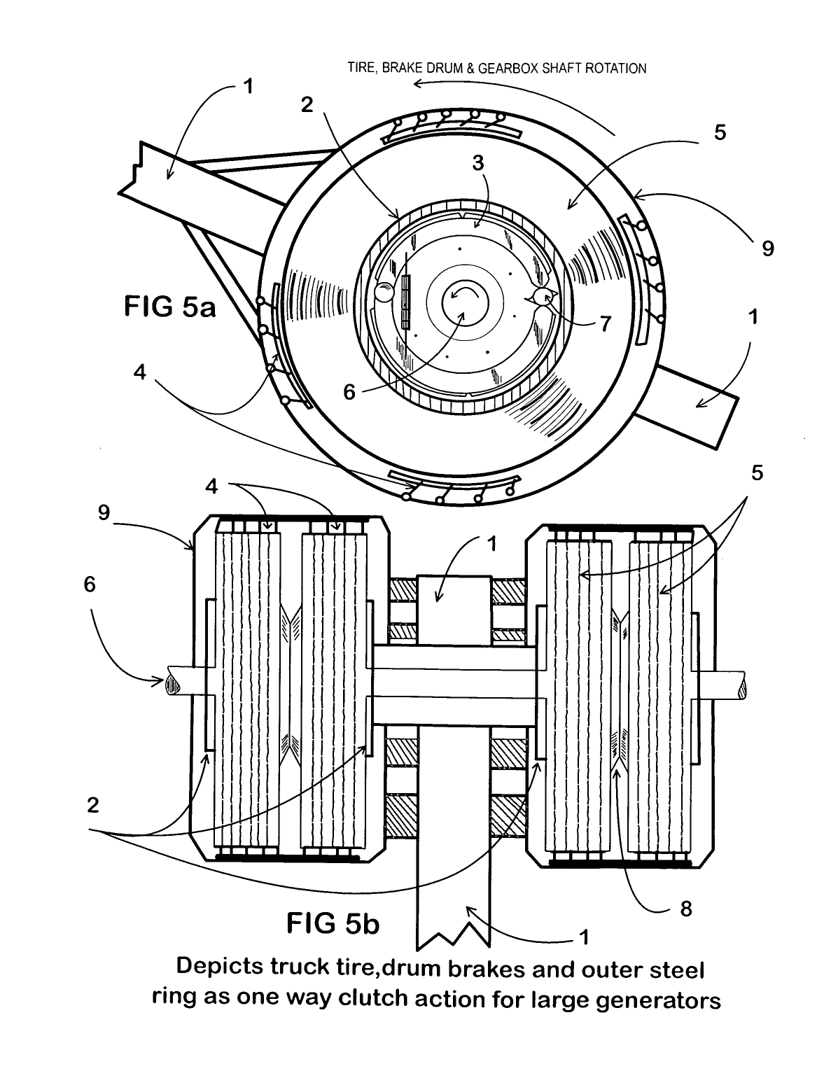

Referring to FIG. 5 is the so called one-way clutch method applied in the present invention to the shaft 6 with enormous amount of torque can be applied by adding additional unit of the said one-way clutch assemblies on both side of the long rigid arm FIG. 5b as ribs of a fork attached to each long rigid arm to ratchet reciprocation the arms to turn the gearbox shaft 6 whereby generator to maintain the rpm as designed, as in FIG. 5a a truck tire is encased with thick metal band 9 attached to the long rigid power arm 1, along with brake shoes 3 and brake shoes backing plate is fixed to the long rigid power arm and where the brake drum 2 is also fixed to gearbox shaft along with the tire, tire rim 8, thus upon the cam 7 applied by external means the brakes are applied and the shaft 6 is locked to the drum 2 as the long rigid power arm 1 descends turns the gearbox shaft 6 along with the thick metal band 9 is binding the tire 5 with the “Z” type metal strip 4 as it binds to the tire causing the rotation of the tire 5 and the gearbox shaft 6, upon the rise of the long rigid power arm the tire 5 is released by “Z” type metal strip 4 and the brakes 3 are released at same time causing the gearbox shaft to be free, this action of binding the tire 5 to the thick metal band 9 and brakes 3 applied to the drum 2 causes the long rigid arm 1 to overcome an enormous torque applied by the gearbox shaft 6 whereby the generator.

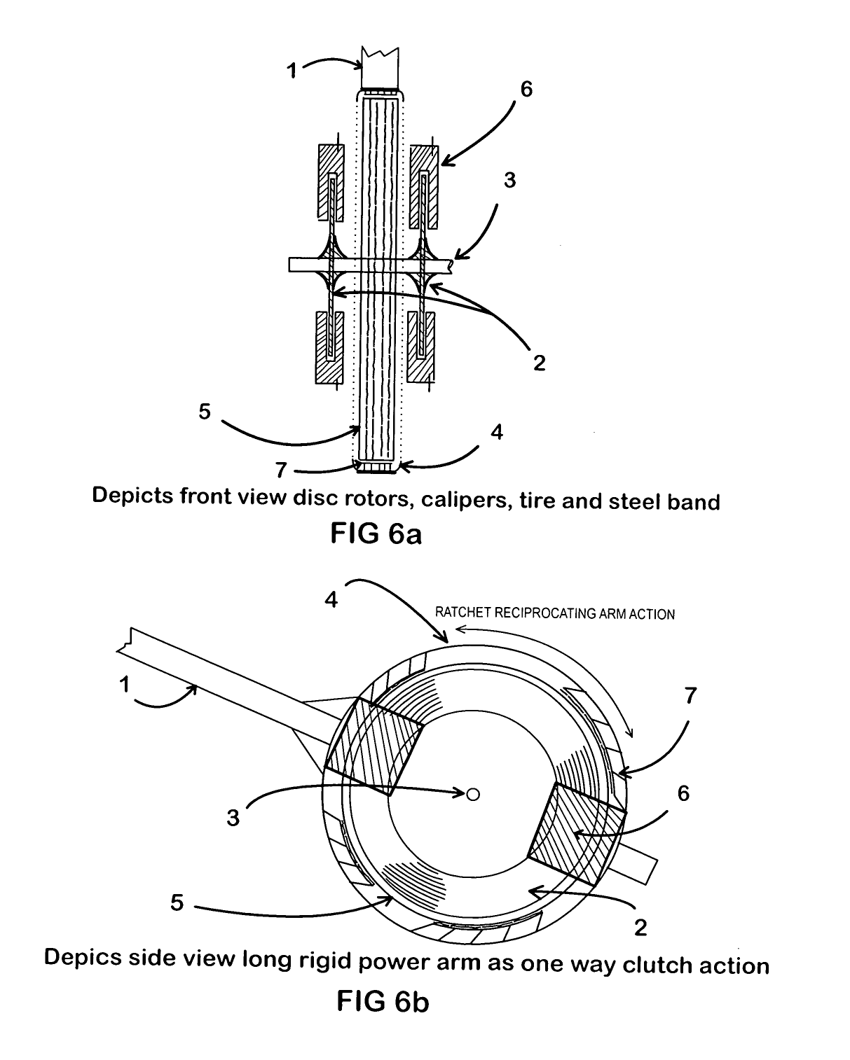

Referring to FIG. 6 by using the car tire 5 and brake rotor 2 and caliper 6 or large 17 inch motor cycle rotor 2 and caliper 6 and large tire 5 as a one way clutch method been implemented in the present invention to accommodate a one way clutch action, the long rigid arm is attached with a thick metal band 4 around the tire with “Z” type metal strip 7 to bind the tire in one direction of reciprocating of the long rigid power arm 1 along with calipers applied lock the rotors whereby to turn the gearbox shaft positively in one direction and release the opposite direction, this method would be used in medium size generators.

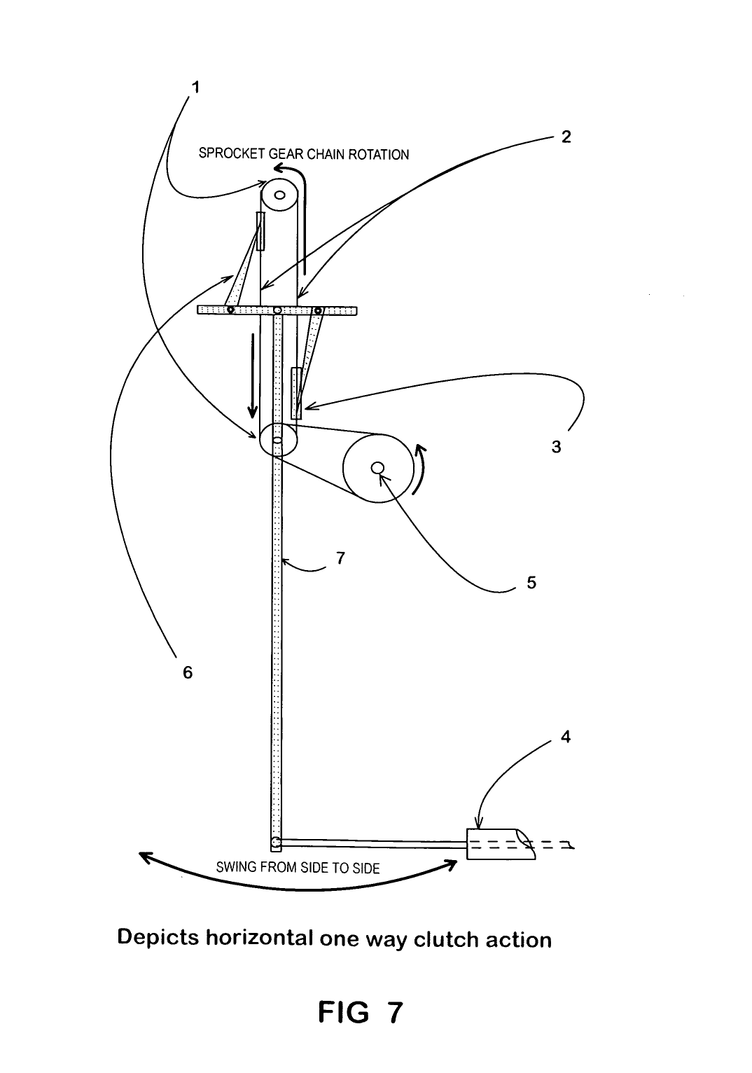

Referring to FIG. 7 where two identical sprocket type gears 1, are set apart on a frame with roller chain 2 connected in a loop between the two said sprocket gears 1, the mid section of the said frame one end of a long rigid power arm is pivoted as shown “T” junction in FIG. 7 with two sets jaw clamp 3 extended on long levers is spring loaded to lock on to the chain in one direction and release the other direction, on each side of the chain so to pull the chain in one direction on either side of the sprocket chain track 2, as the long rigid power arm 7 move from side to side upon the swinging toward the right as in this case motion pulling the chain 2 with both the sets of jaw clamps 3 and releasing them during the left motion, this action is caused by the two long jaw clamps 3 been attached to the long rigid arm a short distance from the pivoted point causing 6 a leverage action on pulling the roller chain whereby turning the two sprocket gears 1, in one direction positively (slip-grip action), whereby turning the gearbox shaft 5 attached one of sprocket gear, addition jaw clamps with spring loaded can be installed, this entire mechanism can be operated horizontally as long rigid arms operate from side to side and the said arms operated by air/hydraulic cylinder 4 to reciprocate the long rigid power arm.

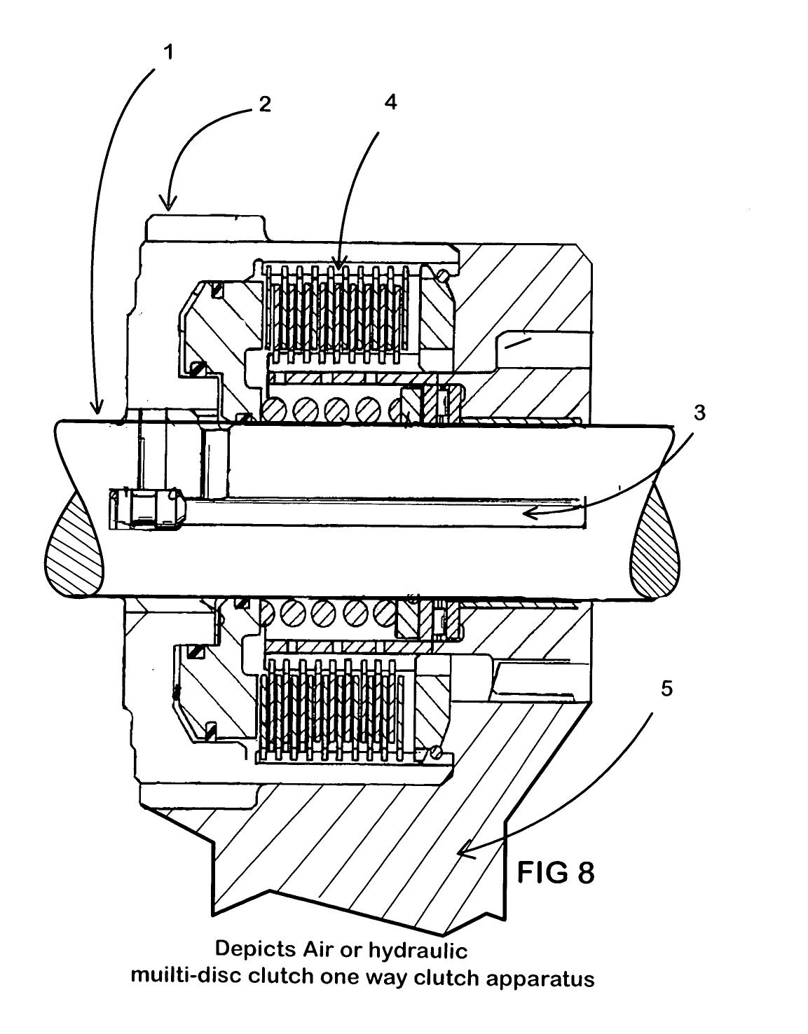

Referring to FIG. 8, multi-disc one way clutch apparatus to turn the gearbox shaft 1, hydraulically or pneumatic 3, thus causing the row of clutches 4 are applied during the downward stroke of the long rigid power arm 5 and released and disengaged during upward stroke thus turning the gearbox shaft in one direction during reciprocating of the long rigid power arm 5.

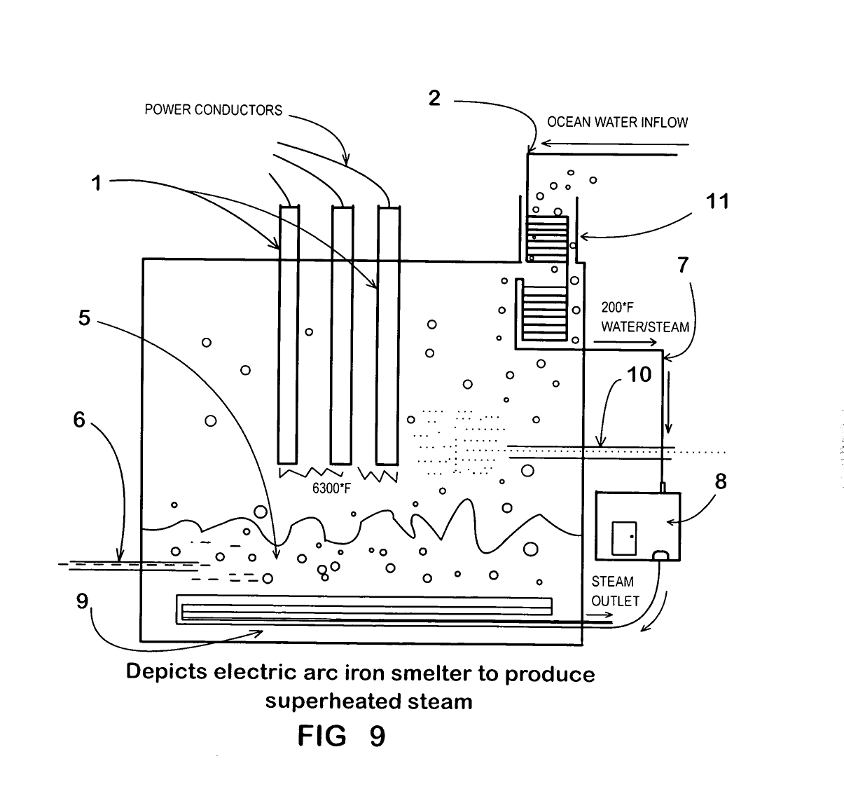

Referring to FIG. 9 there is illustrated of electric-arc furnace, electricity is provided from the long rigid power arm generator of the present invention to the carbon arc electrodes 3 and electric-arcs are formed between the electrodes and/or between the electrodes and the metal. The resulting heat serves to melt the metal thus forming a molten metal 5 bath within the electric-arc furnace. The metal is melted over and over repeatedly to maintain the high temperature for extended period of time continuously been cooled by thick tungsten pipes 9, the heat transfer from molten metal to the water/steam pipes 7. Oxygen is provided into the molten metal bath in gaseous form through lance 6. This primary oxygen may be provided in the form of air or a mixture having an oxygen concentration exceeding that of air. The reaction of oxygen with molten metal bath to provide additional heat to the furnace, thus maintaining the flow of superheat steam in the tungsten steam pipes 9, the water pipes at 2 are wrapped to the inner wall of the smelter's exhaust system 11 to preheat to plus 200 degrees F. and collect the minerals at 8 from the ocean water before entering the furnace. The electrode or electrodes may be totally or partially within the arc flare zone to increase or decrease temperatures in the furnace. In the embodiment illustrated in the figure there are three such electrodes 3. Thus superheated steam is produced efficiently, continuously to supply the turbine generator to produce electricity for the grid.

### ILLUSTRATIVE EMBODIMENTS

Although this invention has been described in certain specific embodiments, many additional modifications and variations would be apparent to those skilled in the art. It is, therefore, to be understood that this invention may be practiced otherwise than as specifically described. Moreover, to those skill in the various arts, the invention itself herein will suggest solutions to other tasks and adaptations for other applications. Thus, the embodiments of the invention described herein should be considered in all respects as illustrative and nor restrictive, the scope of the invention to determined by the appended claims and their equivalent rather than foregoing description.

What is claimed is:

1. A method and the apparatus of the present invention of continuously producing superheated steam and to discontinue the use of current nuclear side of the electric power generating plants and also discontinue the use of current fossil fuel side of the electric power generating plants to produce said superheated steam, by using a method used for electric-arc smelting steel to produce superheated steam, in the present invention the initial electricity needed to operate the electric-arc smelting furnace to produce superheated steam is achieved by references cited patent U.S. Ser. No. 13/136,012 and with certain improvement and modification on the said invention as shown in drawings.

2. A method and the apparatus of the present invention of continuously producing superheated steam which comprises of claim 1, as many as required per design the long rigid ratcheting and reciprocating power arms 6 with extension platform 5 with lead weights as shown in FIG. 2 to overcome the torque required to turn the generator's required rpm of the said invention, upon downward reciprocating applied torque from the generator on the long rigid power arms is further overcome by increasing the mass weight by extending the arms with lead weights on the long rigid power arm, thus increasing gravitational pressure to the long rigid arms overall.

3. A method and the apparatus of the present invention of continuously producing superheated steam which comprises of claim 1, upon the upward motion of the long rigid arms 6 in FIG. 1 on the upright sprocket gear 2 and chain 1 frame mechanism, the long rigid power arm with lead weights is retracted by a conveyor type mechanism 10, thus the rear heavier 1000 lb lead weight as in this case is retracted pass the pivoted point 9 of the gearbox shaft, additionally the said weight is further pushed back a short distance by a linear roller type ball screw driver and/or sprocket and roller chain conveyor type apparatus and/or air/hydraulic cylinder 13 thus as the weight of the arm towards the front is reduced drastically by the heavier rear lead weight load is retracted causing the lighter load in front become lighter to lift.

4. A method and the apparatus of the present invention of continuously producing superheated steam which comprises of claim 1, FIG. 4 for electromagnetic suspension (EMS), electronically controlled electromagnets in that the load attract it to a magnetically conductive (usually steel) track and electro-dynamic suspension (EDS) uses permanent magnets which create a magnetic field that induces currents in nearby metallic conductors when there is relative movement which pushes the load away so called magnetic levitation on the rail, the repulsive force in the track is created by an induced magnetic field 3 in wires or other conducting strips in the track, where the long rigid power arm swings as it's ratcheting and reciprocating as in this case caused by magnets moving the 1000 lb weights combine as one unit from side to side to create gravitation force on both side of the swing and the one way clutch apparatus along with the magnetic propulsion coils are controlled and regulated by micro-processor, thus the required rpm is maintained to the generator.

5. A method and the apparatus of the present invention of continuously producing superheated steam which comprises of claim 1, the control of the long rigid ratcheting and reciprocating power arms can be achieved by several method such as hydraulic or pneumatic cylinders, roller type ball screw, controlled by micro processor, as in this case by a sprocket gears and roller chain mechanism in a frame as shown in FIG. 3, the sprocket gears in this frame are of identical in size to maintain the timing of the long rigid power arms to ratchet and reciprocate the power arms to maintain a continuous rotation as a one way clutch action of the input gearbox shaft whereby maintain required rpm for the generator designed frequency, the side view in FIG. 3 as in this case shows the number of long rigid power arms that are going upward and the number of long rigid arms going downward as to cause a continuous rotation of the gearbox shaft and to share the torque required to turn the generator equally, thus these roller chains play a vital role to evenly space the upward and the downward motion of each long rigid power arms separately and to continuously cause the long rigid power arms to reciprocate by following the chain's circular motion around the top sprocket gears and the bottoms sprocket gear on a specific location on the roller chain by linear bearing pillar block and motion system thus causing the attachment of the rigid power arm to the roller chain as it move back and forth, up and down while been attached to the chain on the sprocket gear and roller chain frame at specific location on the chain.

6. A method and the apparatus of the present invention of continuously producing superheated steam which comprises of claim 1, a new use of the existing technologies, large auto and truck tires, rims and braking system as a large super high torque, one-way clutch apparatus as shown in FIG. 6a-6b car tire, rim and/or disc rotor, calipers for smaller generators and FIG. 5a-5b truck tires, rim and brake drums and braking mechanism as a one-way clutch apparatus for larger generators, the said apparatus can be fabricated to any size, is fixed to the gearbox shaft at the generator end of the long rigid power arm, a large thick rigid stainless steel band attached to the said rigid power arm, which is wrapped around the tires with “Z” type pawl spring loaded to metal strip device attached around the inner side of the thick rigid steel band between the tire and the steel band to lock in one direction, together with the brake mechanism operated and controlled mechanically and/or microchip-processor, so as to combine as one unit of the said long rigid power arm, thus causing ratchet reciprocating action as one-way clutch (slip-grip action) of the said long rigid power arms whereby causing a continuous rotation of the gearbox shaft for small KW generators or large MW generator units.

7. A method and the apparatus of the present invention of continuously producing superheated steam which comprises of claim 1, a one way clutch action apparatus shown in FIG. 7, using two sprocket gears 1 of same size separated apart on a frame and at midpoint of the frame the long rigid arm 7 is pivoted by “T” junction 6 where two short extension with jaws to the chain 2 are attached with metal binders in form of two jaws 3 binds and pull roller chain 2 in one direction and release the chain in opposite direction (slip-grip action) of the long rigid power arm thus causing to turn the sprocket 1 in one direction, the long rigid arm 7 is operated horizontally by a pneumatic/hydraulic cylinder 4 repeatedly controlled by micro-processor thus turning gearbox shaft 5.

8. A method and the apparatus of the present invention of continuously producing superheated steam which comprises of claim 1, FIG. 8 with methods of mechanical ratchet causing a continuous rotation of the gearbox shaft whereby the generator, as the long rigid power arms 5 reciprocate one end of the arm attached to clutches and steel plates 4 in a sleeve around the gearbox shaft 1 where multiple clutch and steel plates 4 are applied and released in a drum 2 fixed to the gearbox shaft or vise versa repeatedly either hydraulically or pneumatically to lock in one direction and release in the other direction causing (slip-grip action) a continuous rotation on the gearbox shaft at low rpm.

9. A method and the apparatus of the present invention of continuously producing superheated steam which comprises of claim 1, FIG. 9 there is illustrated of electric-arc furnace, electricity is provided from the long rigid power arm generators to the carbon arc electrodes 1 and electric-arcs are formed between the electrodes and/or between the electrodes and the metal. The resulting heat serves to melt the metal thus forming a molten metal 5 bath within the electric-arc furnace. The metal is melted over and over repeatedly to maintain the high temperature for extended period of time continuously been cooled by thick tungsten pipes 9, where the heat transfer from molten metal to the water/steam pipes 7 takes place. Oxygen is provided into the molten metal bath in gaseous form through lance 6, and air through 10, the reaction of oxygen with molten metal bath to provide additional heat to the furnace, thus maintaining the flow of superheat in the tungsten steam pipes 9, the ocean water pipes at 2 are wrapped to the inner wall of the smelter's exhaust system 11 to preheat to 200 degrees F. and higher to collect the minerals at 8 from the ocean water before entering the furnace, thus superheated steam is produced efficiently, continuously to supply the turbine generator to produce electricity for the grid.

10. A method and the apparatus of the present invention of continuously producing superheated steam which comprises of claim 1, as the ocean water is converted to superheated steam by the electric-arc smelting furnace and is processed through the turbine generator to produce electrical power, thereafter low pressure steam is reheated, reused, then converted to clean drinking water through condensation and distillation.

11. A method and the apparatus of the present invention of continuously producing superheated steam which comprises of claim 1, this entire operation of controlling the reciprocating of the long rigid power arms, the sliding of the platform with heavy lead weights, long swinging arms can be operated with DC power with rechargeable storage batteries and/or direct AC power.

12. A method and the apparatus of the present invention of continuously producing superheated steam which comprises of claim 1, any one or a combination thereof or multiple units of the so called one way clutch apparatus (sprag bearing, ratchet action mechanism) slip-grip action described in the present invention can be implemented to the long rigid power arm to turn the gearbox shaft whereby the generator continuously.
